(19) United States
(12) Patent Application Publication
(10) Pub. No.: US 2014/0139011 A1
(43) Pub. Date: May 22, 2014

(54) INTEGRATED-TYPE SPOKE STRUCTURE, MANUFACTURING METHOD THEREOF, WHEEL ASSEMBLY FOR BICYCLE HAVING THE SAME AND MANUFACTURING METHOD THEREOF

(71) Applicants: Chang Bok KO, (US); Jeong Rae KIM, (US)

(72) Inventors: Chang Bok KO, (US); Jeong Rae KIM, (US)

(73) Assignee: MANDO CORPORATION, Pyeongtaek-si (KR)

(21) Appl. No.: 13/683,624

(22) Filed: Nov. 21, 2012

(51) Int. Cl. B60B 3/10; B60B 5/02; B60B 1/14; B29C 69/02

(52) U.S. Cl. CPC B60B 3/10; B29C 69/02; B60B 5/02; B60B 1/14
USPC 301/64.101; 264/250; 29/894.342

(57) ABSTRACT

An integrated type spoke structure, a wheel assembly for a bicycle having the same, and a manufacturing method thereof, the integrated type spoke structure for a spoke coupled to a rim, the spoke including a reinforcing member provided at an end portion of the spoke formed of plastic, and a hub provided at a center of the spoke, wherein the reinforcing member and the hub are formed of material having rigidity larger than a rigidity of the spoke, and are integrally formed with each other through an injection molding.

### CROSS-REFERENCE TO RELATED APPLICATION

This application claims the benefit of Korean Patent Application No. 2012-0104248, filed on Sep. 19, 2012 in the Korean Intellectual Property Office, the disclosure of which is incorporated herein by reference.

### BACKGROUND

1. Field

Embodiments of the present disclosure relate to an integrated-type spoke structure, a manufacturing method thereof, a wheel assembly for a bicycle having the same, and a manufacturing method thereof, and more particularly, to an integrated-type spoke structure capable of enabling a motor to be easily installed at a motor driven bicycle and ensuring easy manufacturing and easy assembly process, a manufacturing method thereof, a wheel assembly for a bicycle having the same, and a manufacturing method thereof.

2. Description of the Related Art

In general, a bicycle is a means of transportation for a short distance, and widely used for enhancement of heath or as a hobby.

The bicycle as such is constituted by including a frame forming a body of the bicycle, a handle, a saddle and a front wheel and a rear wheel (hereinafter referred to as a wheel in common) installed at a front side and a rear side of the frame, respectively.

The wheel is provided with a predetermined rigidity to support the weight of the bicycle, the weight of a user or the weight of a load carried by a user. For example, the wheel is constituted by including a rim formed of metal and having a tire installed at an outer surface thereof, a hub to which a rotary shaft of the wheel is coupled, and a spoke connecting the hub to the rim. The wheel may be formed in an integrated type wheel for the convenience of the manufacturing process.

However, the spoke connecting the hub to the rim is needed to be formed using a plurality of steel lines connecting the rim to the hub while having a predetermined tension, causing a difficulty in the installation and increasing the manufacturing time. If the spoke is formed of metal, a desired rigidity is provided but the material cost is increased.

In addition, the integrated type wheel formed of plastic has a low rigidity and may be easily damaged by external impact.

Further, the integrated type wheel needs to be provided with a hub coupled to the rotating shaft.

### SUMMARY

Therefore, it is an aspect of the present disclosure to provide an integrated-type spoke structure, a manufacturing method thereof, a wheel assembly for a bicycle having the same, and a manufacturing method thereof, capable of reducing the weight and the manufacturing cost while improving the rigidity.

It is another aspect of the present disclosure to provide an integrated-type spoke structure, a manufacturing method thereof, a wheel assembly for a bicycle having the same, and a manufacturing method thereof, capable of ensuring easy manufacturing, and if necessary, enabling easy replacement of the wheel.

Additional aspects of the disclosure will be set forth in part in the description which follows and, in part, will be obvious from the description, or may be learned by practice of the disclosure.

In accordance with one aspect of the present disclosure, an integrated-type spoke structure of a spoke coupled to a rim, the integrated-type spoke structure includes a reinforcing member and a hub. The reinforcing member may be provided at an end portion of the spoke formed of plastic. The hub may be provided at a center of the spoke. The reinforcing member and the hub may be formed of material having rigidity larger than a rigidity of the spoke, and may be integrally formed with the spoke through an injection molding.

The spoke may be provided with a plurality of support members radially extending from a center thereof, and the support member, the hub and the reinforcing member are integrally formed with one another through an insert injection.

In accordance with another aspect of the present disclosure, a wheel assembly for an electric bicycle, the wheel assembly includes a rim and a spoke. The rim may be provided in a ring shape and have a rubber wheel installed at an outer circumferential surface thereof. The spoke may be formed as an integral body provided with a plurality of support members, which is formed of plastic and radially extending from a center thereof, and provided at the center thereof with a hub, which is formed of material having a rigidity larger than a rigidity of the support member and to which a rotating shaft of the rubber wheel is coupled. An end portion of each of the plurality of support members may be coupled to an inner circumferential surface of the rim.

A reinforcing member formed of material having a rigidity larger than a rigidity of the support member may be provided at the end portion of the support member that is coupled to the rim to improve the rigidity of the rubber wheel.

The reinforcing member may be integrally formed with the support member through an insert injection.

The reinforcing member facing the rim may be provided with a fastening groove having a screw thread, and the rim may be provided with a through hole at a position corresponding to the fastening groove, so that the rim is coupled to the spoke by screwing a fastening bolt to the fastening groove while passing through the through-hole.

The wheel assembly may further include a hub cap installed at the hub to surround an end portion of the hub that is coupled to the rotating shaft of the rubber wheel.

In accordance with another aspect of the preset disclosure, a method of manufacturing an integrated-type spoke structure includes steps of (a1) and (b1). In the step (a1), a hub and a reinforcing member that each has a predetermined rigidity may be molded. In the step (a1), the hub and the reinforcing member are inserted in a mold, and a spoke which is integrated with the hub and the reinforcing member is molded through an injecting molding. The hub and the reinforcing member may each have a rigidity larger than a rigidity of the spoke.

In the step (b1), the spoke may be provided with a plurality of support members radially extending from a center thereof. The spoke may be molded by disposing the hub at the center of the spoke and disposing the reinforcing member at an end portion of the support member.

In accordance with another aspect of the present disclosure, a method of manufacturing a wheel assembly of an electric bicycle includes steps of (a2) and (b2). A rim having a predetermined rigidity and provided in a shape of a ring may be formed. The spoke structure, which is manufactured through claim 8 or claim 9, may be installed on the rim.

As described above, a support member formed of plastic is integrally formed with a hub and a reinforcing member, which have rigidity larger than that of the support member, through an injection molding, so that the cost and weight are reduced while improving the rigidity.

In addition, since the spoke having the hub integrally formed with the support member is provided, the spoke is easily replaced with respect to the rim. Since insert injection is available for manufacturing the spoke, various designs are implemented and adopted.

Meanwhile, a reinforcing member is selectively adopted at an end portion of the support member coupled to the rim, so that the rigidity is further improved depending on the demand of a user.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating an electric bicycle in accordance with one embodiment of the preset disclosure.

FIG. 2 is a plan view of FIG. 1

FIG. 3 is a side view of FIG. 1.

FIG. 4 is an exploded perspective view illustrating a wheel assembly of the electric bicycle in accordance with the one embodiment of the preset disclosure.

FIG. 5 is an assembled perspective view of FIG. 4.

### DETAILED DESCRIPTION

Reference will now be made in detail to the embodiments of the present disclosure, examples of which are illustrated in the accompanying drawings, wherein like reference numerals refer to like elements throughout.

The present disclosure is characterized in a wheel assembly for an electric bicycle, a spoke provided on a wheel and a manufacturing method thereof. Prior to the description of the characteristics of the present disclosure, an electric bicycle adopted with the present disclosure will be described in brief.

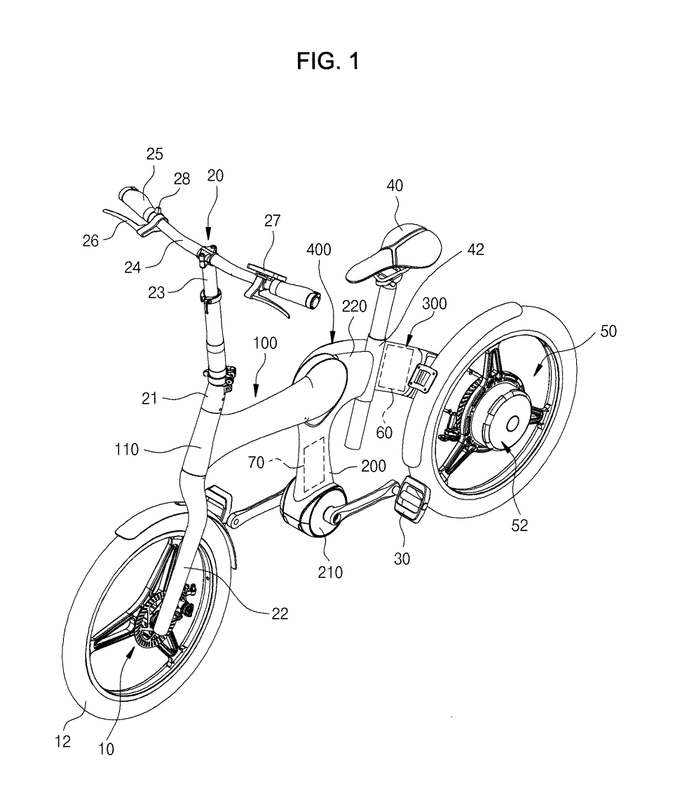

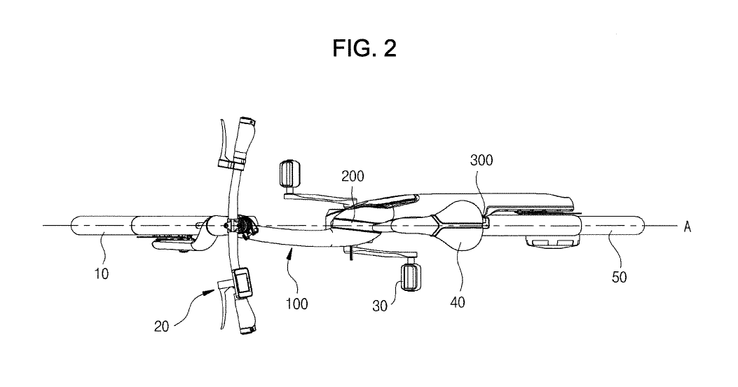

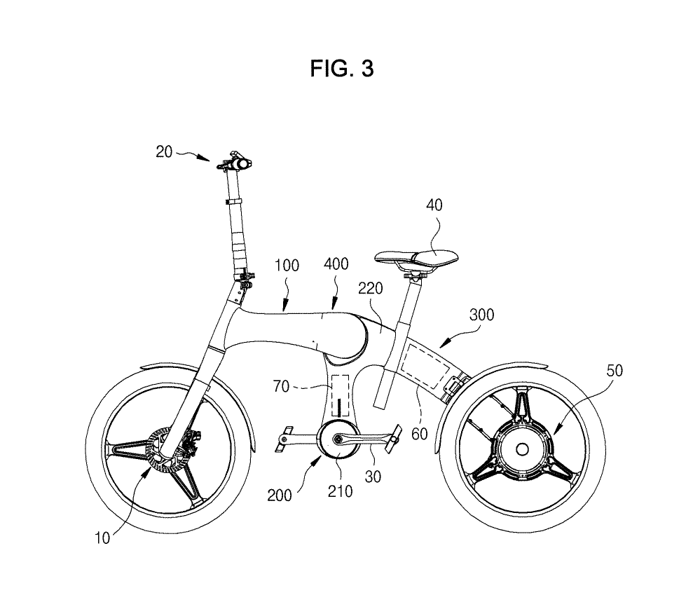

FIG. 1 is a perspective view illustrating an electric bicycle in accordance with one embodiment of the preset disclosure, FIG. 2 is a plan view of FIG. 1, and FIG. 3 is a side view of FIG. 1.

Referring to FIGS. 1 to 3, an electric bicycle in accordance with an embodiment of the present disclosure includes a front frame 100 provided with a front wheel 10 and a handle portion 20, a center frame 200 provided with a pedal 30 and a saddle 40, and a rear frame 300 provided with a rear wheel 50. The front frame 100, the center frame 200 and the rear frame 300 are coupled to one another so as to be rotated on a hinge coupling portion 400 of the center frame 200.

The front frame 100 is provided in the form of a bar having an interior space. A handle tube 110 is provided at one end of the front frame 100, and the center frame 200 is rotatably coupled to the other end of the front frame 100. The handle tube 110 is provided in hollowness such that a handle stem 21 is rotatably coupled to the handle tube 110. The handle stem 21 is provided with a front wheel fixing frame 22 at a lower side of the handle tube 110, and provided with a handle fixing frame 23 at an upper side of the handle tube 110. The front wheel fixing frame 22 is provided by partially bending the handle stem 21 from a center to a lateral side such the front wheel 10 is disposed in the same line (‘A’ of FIG. 2) with the rear wheel 50. The handle fixing frame 23 supports the center of a handle bar 24 that is provided in the form of a bar. Each end portion of the handle bar 24 is provided with a grip 25 and a brake lever 26 for braking the front wheel 10 and the rear wheel 50. A display apparatus 27 is detachably installed at one side of the handle bar 24 to display information of the electric bicycle, such as speed change or battery of the electric bicycle, and a lever 28 is installed at the other side of the handle bar 24 for speed change.

The center frame 200 has an interior space and is provided in the form of a bar. The pedal 30 is provided at one end of the center frame 200, and the front frame 100 and the rear frame 300 are rotatably coupled to the other end of the center frame 200. The one pair of pedals 30 is provided so as to be rotated on a pedal coupling portion 210 provided on the center frame 200. At an inside of the pedal coupling portion 210, a generator (not shown) is provided to convert a rotary power of the pedal 30 into an electric energy, and the electric energy charges a battery 60 electrically connected to the generator. At the interior space of the center frame 200, an engine control unit (ECU) 70 is provided for the electrical connection and control between the generator and other electronic components.

In addition, the center frame 200 may include a saddle frame 220 on which the saddle 40 is installed. The saddle frame 220 is provided at a rear side thereof with a saddle tube 42 on which the saddle 40 is installed. A saddle rod (not shown) is coupled to the saddle tube 42 to adjust the height of the saddle 40.

The rear frame 300 has an interior space and provided in the form of a bar. The rear wheel 50 is rotatably installed at one end of the rear frame 300, and the center frame 200 is rotatably installed at the other end of the rear frame 300.

At the interior space of the rear frame 300, the battery 60 and a battery management system (not shown) are provided that are electrically connected to the ECU 70 provided on the center frame 200. The motor installed on the rear frame 300 is disposed on the rear wheel 50. The motor (not shown) is accommodated in a hub 13 that is installed on the rear wheel 50, and configured to rotate the rear wheel 50 by receiving a driving force from the battery 60 according to the control of the ECU 70.

In this case, the motor is implemented using an outer rotor scheme. The outer rotor scheme is a type of a motor driving scheme, which has a fixed center shaft and a rotor disposed at a periphery of the center shaft, and the rotor is connected to a rotating body, such as a wheel, to rotate together with the rotating body.

As described above, the front frame 100, the center frame 200 and the rear frame 300 are provided in a foldable structure that enables the front frame 100 and the rear frame 300 are rotated on the center frame 200 by the hinge coupling portion 400.

Hereinafter, a motor housing integrated-type spoke structure and a wheel assembly having the same will be described in detail. The wheel assembly may be used for as the front wheel 10 or the rear wheel 50 of the electric bicycle described above. Although the description is made in relation to an electric bicycle having a foldable structure and operated on electricity using a motor, a battery, and ECU, the present disclosure is not limited thereto. Alternatively, the wheel assembly in accordance with the present disclosure may be applied to a front wheel or a rear wheel of a general bicycle other than the electric bicycle.

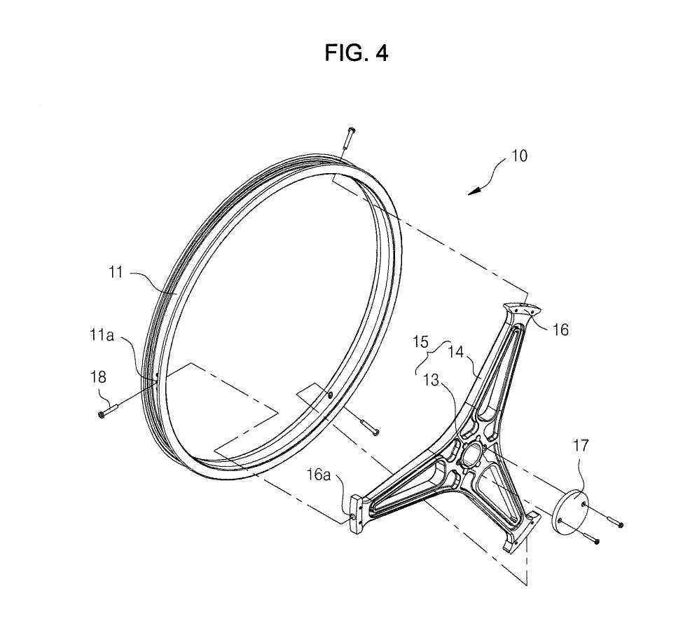

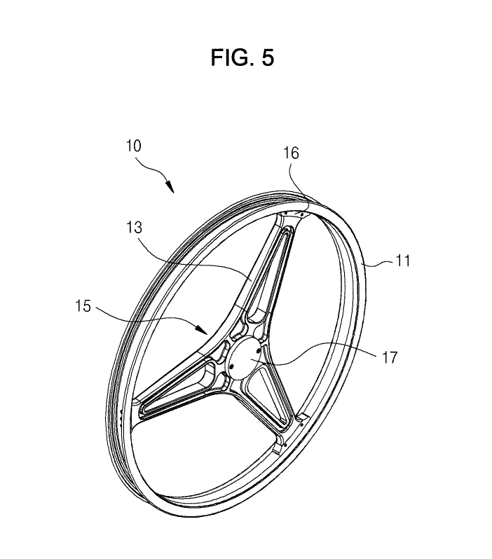

FIG. 4 is an exploded perspective view illustrating a wheel assembly of the electric bicycle in accordance with the one embodiment of the preset disclosure. FIG. 5 is an assembled perspective view of FIG. 4.

Referring to FIGS. 4 and 5, the wheel assembly is provided with a rim 11 having a ring shape, and a spoke 15 coupled to the rim 11.

The rim 11 is formed of metal, for example, an aluminum alloy, to improve the rigidity of the rim 11. A tire (‘12’ in FIG. 1) is installed at an outer circumferential surface of the rim 11.

A spoke structure in accordance with the present disclosure is rotatably installed on the front wheel fixing frame (22 in FIG. 1). The spoke structure is provided with a plurality of support members 14, which are radially extending from a center thereof, and a hub 13 coupled to a rotating shaft (not shown) of the wheel 10.

In more detail, the spoke structure is formed as an integral body by integrally forming the hub 13, which has rigidity larger than that of the support member 14 with the center of the spoke 15 having the plurality of support members 14 formed of plastic, through an injection molding. In this case, the hub 13 may be formed of metal having rigidity larger than that of the support member 14, for example, an aluminum alloy. Other material having rigidity larger than that of the support member 14 may be available for the material of the hub 13.

The spoke 15 has an end portion of each support member 14 installed at an inner circumferential surface of the rim 11. In order to improve the rigidity of the spoke 15, a reinforcing member 16 may be provided at the end portion of each support member 14. The reinforcing member 16 may be formed of material having rigidity larger than that of the support member 14, for example, an aluminum alloy, tungsten, and stainless steel.

The reinforcing member 16 may be integrally formed with the support member 14 through injection molding, similar to the hub 13. That is, the spoke structure is molded as an integral body including the plurality of support members 14, the hub 13 and the reinforcing member 16 through an injection molding. The injection molding may be implemented using an insert molding process.

A method of manufacturing the spoke structure is as follows. First, the hub 13 and the reinforcing member 16 each having a predetermined rigidity are formed. Thereafter, the hub 13 and the reinforcing member 16 are inserted into a mold, and the spoke 15 having the plurality of support member 14 and formed of plastic is formed while being integrated with the hub 13 and the reinforcing member 16 through an injection molding. In this case, the spoke structure is molded such that the hub 13 is disposed on the center of the spoke 15 while the reinforcing member 16 is disposed at each end portion of the support member 4, as an integral body as shown in FIG. 4.

The rim 11 having a ring shape is manufactured before the manufacturing of the spoke structure as such, and the spoke structure is manufactured as such and coupled to the rim 11, thereby completing the manufacturing of the wheel assembly.

The spoke structure is coupled to the rim 11 in a manner to couple the spoke structure to the inner circumferential surface of the rim 11 through a fastening bolt 18. That is, the reinforcing member 16 provided at each end portion of the support member 14 coupled to the rim 11 is provided with a fastening groove 16a having a screw thread formed at an inner circumferential surface thereof, and the rim 11 is provided with a through-hole 11a at a position corresponding to the fastening groove 16a. Accordingly, by screwing a fastening bolt 18 to the fastening groove 16a through the through-hole 11a, the spoke structure is coupled to the rim 11.

Meanwhile, reference numeral ‘17’ represents a hub cap that is installed on the hub 13 to cover an end portion of the hub 13 that is coupled to the rotating shaft (not shown) of the wheel 10 to prevent foreign substances from being introduced into between the hub 13 and the rotating shaft.

As described above, the wheel assembly as such is manufactured by separately preparing the spoke structure and the rim, and then forming the spoke structure, which is integrated with the support member 14 and the hub 13 of different material through an insert injection, thereby reducing the cost and the weight. In addition, no installation component is needed to install the motor, thereby ensuring an easy assembly process.

Although the description has been made in relation that the wheel assembly having the integrated-type spoke structure is configured to be used for the front wheel 50, the present disclosure is not limited thereto. The rear wheel may have the same configuration as the front wheel.

Although a few embodiments of the present disclosure have been shown and described, it would be appreciated by those skilled in the art that changes may be made in these embodiments without departing from the principles and spirit of the disclosure, the scope of which is defined in the claims and their equivalents.

1. An integrated-type spoke structure of a spoke coupled to a rim, the integrated-type spoke structure comprising:
a reinforcing member provided at an end portion of the spoke formed of plastic; and
a hub provided at a center of the spoke,
wherein the reinforcing member and the hub are formed of material having rigidity larger than a rigidity of the spoke, and are integrally formed with the spoke through an injection molding.

2. The integrated-type spoke structure of claim 1, wherein the spoke is provided with a plurality of support members radially extending from a center thereof, and the support member, the hub and the reinforcing member are integrally formed with one another through an insert injection.

3. A wheel assembly for an electric bicycle, the wheel assembly comprising:
a rim provided in a ring shape and having a rubber wheel installed at an outer circumferential surface thereof; and
a spoke formed as an integral body provided with a plurality of support members, which is formed of plastic and radially extending from a center thereof, and provided at the center thereof with a hub, which is formed of material having a rigidity larger than a rigidity of the support member and to which a rotating shaft of the rubber wheel is coupled,
wherein an end portion of each of the plurality of support members is coupled to an inner circumferential surface of the rim.

4. The wheel assembly of claim 3, wherein a reinforcing member formed of material having a rigidity larger than a rigidity of the support member is provided at the end portion of the support member that is coupled to the rim to improve the rigidity of the rubber wheel.

5. The wheel assembly of claim 4, wherein the reinforcing member is integrally formed with the support member through an insert injection.

6. The wheel assembly of claim 4, wherein the reinforcing member facing the rim is provided with a fastening groove having a screw thread, and the rim is provided with a through hole at a position corresponding to the fastening groove, so that the rim is coupled to the spoke by screwing a fastening bolt to the fastening groove while passing through the through-hole.

7. The wheel assembly of claim 3, further comprising a hub cap installed at the hub to surround an end portion of the hub that is coupled to the rotating shaft of the rubber wheel.

8. A method of manufacturing an integrated-type spoke structure, the method comprising:
(a1) molding a hub and a reinforcing member that each has a predetermined rigidity; and
(b1) inserting the hub and the reinforcing member in a mold, and molding a spoke which is integrated with the hub and the reinforcing member through an injecting molding,
wherein the hub and the reinforcing member each have a rigidity larger than a rigidity of the spoke.

9. The method of claim 8, wherein in the step (b1),
the spoke is provided with a plurality of support members radially extending from a center thereof, and
wherein the spoke is molded by disposing the hub at the center of the spoke and disposing the reinforcing member at an end portion of the support member.

10. A method of manufacturing a wheel assembly of an electric bicycle, the method comprising:
(a2) forming a rim having a predetermined rigidity and provided in a shape of a ring; and
(b2) installing the spoke structure, which is manufactured through claim 9, on the rim.
